(19) United States
(12) Patent Application Publication
(10) Pub. No.: US 2006/0226366 A1
(43) Pub. Date: Oct. 12, 2006

(54) Infrared detector

(75) Inventors: Yutaka Tanaka, Kawasaki (JP); Tsunenori Iribe, Tokyo (JP)

Correspondence Address: YOUNG & THOMPSON, 745 SOUTH 23RD STREET, 2ND FLOOR, ARLINGTON, VA, 22202, US

(73) Assignees: NEC ELECTRONICS CORPORATION, KAWASAKI (JP); NEC CORPORATION, TOKYO (JP)

(21) Appl. No.: 11/401,872

(22) Filed: Apr. 12, 2006

(30) Foreign Application Priority Data
Apr. 12, 2005 (JP) 2005-115117

(51) Int. Cl. G01J 5/00

(52) U.S. Cl. 250/338.1

(57) ABSTRACT

An infrared detector having pixels which convert the infrared ray into an electric signal and are arranged to form a matrix. An infrared detecting unit is placed in a vessel having a shielding member for preventing the incident infrared radiated from the target object from being inputted to reference pixels. Only the infrared ray radiated from the shielding member is inputted to the reference pixels. The amount of infrared ray received by the reference pixels is supposed to equal the amount of infrared ray radiated from the inner wall of the vessel. The pixels other than the reference pixels receive the infrared ray both from the target object and the inner wall of the vessel. The circuit for reading out the electric signal generated by the pixels reads out the electric signal from the pixels using the electric signal from the reference pixels as a reference point.

### BACKGROUND OF THE INVENTION

1. Field of the Invention

The present invention relates to an infrared detector and readout electronics for the same.

2. Description of the Related Art

A thermal infrared detector in which a bolometer is used is known. This type of detector converts the temperature distribution of a subject into a picture image. The bolometer is a device for detecting the infrared ray by applying the phenomenon where the resistance of a resistor is varied in response to the incidence of the infrared ray. This thermal infrared detector has a matrix consisting of a large number of bolometers. The resistance change in each of those bolometers is electrically read, thereby imaging a two-dimensional picture of the subject through the infrared ray.

The infrared ray emitted from the subject is focused on the surface of the detector and transformed into a picture image. However, the radiation heat entered to the detector from the surrounding area is changed in response to the temperature shift of the circumstance of the detector. It is difficult to distinguish the infrared ray caused by this radiation heat and the infrared ray from the subject. Thus, the infrared picture of the subject is disturbed by the temperature shift of the circumstance.

As one example of the conventional techniques, Japanese Laid-Open Patent Application (JP-P 2003-106895A) discloses a technique of a thermal infrared detecting device. This thermal infrared detecting device has a pixel of micro-bridge structure, in which a diaphragm having a bolometer layer is hold in the air by a beam the one edge of which is fixed on a board.

As the other example of the conventional techniques, Japanese Laid-Open Patent Application (JP-A-Heisei, 10-148578) discloses a technique concerning the infrared detector mounting a non-cooled type infrared detecting device which is designed for good performance in the condition not cooled in ultra low temperature, exemplified by a micro bolometer type 2-Dimensional allay infrared detecting device.

The other type of the thermal infrared detector is disclosed in Japanese Laid-Open Patent Application (JP-P 2000-292253A), for reducing the change in a radiation heat entered from the surrounding area of the detector. FIG. 1 shows a conceptual view showing the detector. A thermal infrared detector 101 has a vacuum vessel 103. The vacuum vessel 103 has a window 106 to which the infrared ray from a target 130 is entered. An optical unit 132 is installed outside the vacuum vessel 103 in the direction facing the window 106.

Inside the vacuum vessel 103, a cooling unit 107 is installed on the side opposite to the window 106. An infrared detecting unit 102 having an infrared detecting device for detecting the infrared ray entered from the window 106 is installed on the side oriented to the window 106 of the cooling unit 107. The infrared detecting unit 102 is surrounded by a metallic part shown as a radiation shield 112. The radiation shield 112 is in contact with the cooling unit 107. The radiation shield 112 has an opening for transmitting the infrared ray. The radiation shield 112 blocks the infrared ray from being inputted to the infrared detecting unit 102 from the direction except the window 106.

The vacuum vessel 103 has an exhaust pipe 108 connected to a vacuuming unit. The vacuum vessel 103 further has a connecting terminal 113 for electrically connecting the infrared detecting unit 102 and the outside of the vacuum vessel 103.

When the thermal infrared detector is used, the inside area of the vacuum vessel is made vacuum by being degassed from the exhaust pipe 108 and isolated from the circumstance. Then, the cooling unit 107 is driven. The infrared detecting unit 102 and the radiation shield 112 are cooled by the cooling unit 107.

The infrared detecting unit 102 is driven. The infrared detecting unit 102 detects the infrared ray which is emitted from the target 130 and inputted through the optical unit 132, and converts into an electronic signal. The electronic signal is sent through the connecting terminal 113 to the outside of the vacuum vessel 103.

The infrared ray P1 from the target 130 and the infrared ray P2 from the radiation shield 112 are entered to the infrared detecting unit 102. The infrared ray P3 from the vacuum vessel 103 is not entered to the infrared detecting unit 102 because it is blocked by the radiation shield 112. Since the radiation shield 112 is cooled by the cooling unit 107, the change of the infrared ray P2 from the radiation shield is suppressed.

### SUMMARY OF THE INVENTION

In the thermal infrared detector having the radiation shield, the electric power consumption is increased in order to keep the radiation shield at a constant temperature in addition to the infrared detecting device. Moreover, the installation of the radiation shield makes the size of the vacuum vessel larger.

In order to achieve an aspect of the present invention, an infrared detector includes a: plurality of infrared detecting devices converting an incident infrared ray into an electric signal; a shielding member preventing an infrared ray radiated from a target object from inputted to a reference device which is a part of the plurality of infrared detecting devices; and a circuit configured to read a deviation of an electronic signal generated by a part of the plurality of infrared detecting device from an electronic signal generated by the reference device.

According to the present invention, a thermal infrared detector that is robust against a temperature change in the external environment is provided.

Moreover, according to the present invention, a thermal infrared detector that is small and light is provided.

Moreover, according to the present invention, a thermal infrared detector whose electric power consumption is small is provided.

Moreover, according to the present invention, a thermal infrared detector in which the variable range of the diaphragm of the optical unit is large is provided.

### BRIEF DESCRIPTION OF THE DRAWINGS

FIG. 1 is a conceptual view showing a configuration of a thermal infrared detector of a conventional technique;

FIG. 2 is a conceptual view showing a configuration of a thermal infrared detector;

FIG. 3 shows a positional relation between an infrared detecting device and a light shielding plate;

FIG. 4 shows a sectional view of a pixel;

FIG. 5 shows a positional relation between a light shielding plate and a pixel;

FIG. 6 shows a circuit for reading an electronic signal from the a; and

FIG. 7 shows a circuit for reading an electronic signal from a pixel.

### DESCRIPTION OF THE PREFERRED EMBODIMENTS

A thermal infrared detector in the present invention will be described below in detail with reference to the drawings.

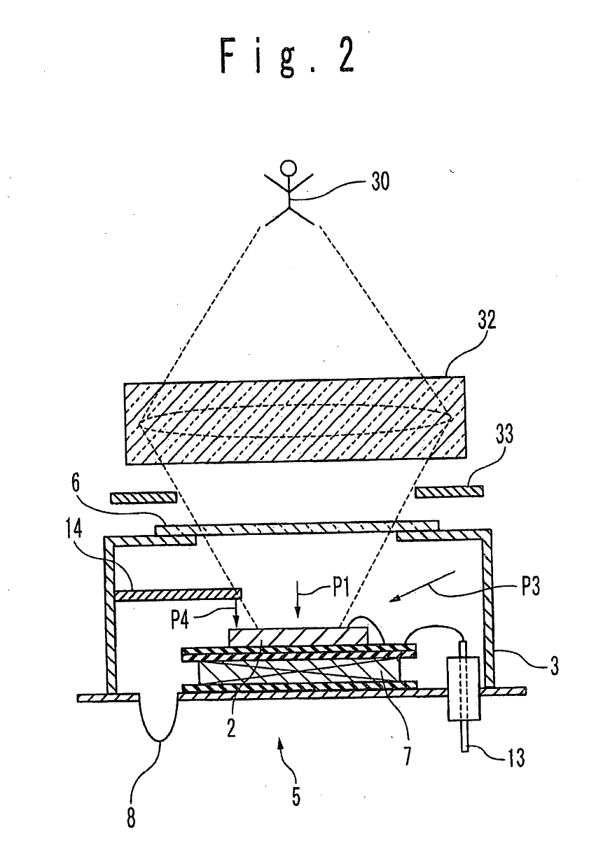

FIG. 2 is a conceptual view of a thermal infrared detector 5. The thermal infrared detector 5 has a vacuum vessel 3. A window 6 through which the infrared ray from a target 30 enters is fixed on one side of the vacuum vessel 3 by welding. An optical unit 32 is installed outside the vacuum vessel 3 in the direction facing the window 6. A diaphragm unit 33 for changing a diaphragm of the optical unit 32 is attached to the optical unit 32.

A cooling unit 7 having an electronic cooling device that uses the Peltier effect is installed inside the vacuum vessel 3. An infrared detecting unit 2 where infrared detecting devices for detecting the infrared ray entered from the window 6 are placed in the arrangement of a matrix is installed on the highest portion (the side oriented to the window 6) of the cooling unit 7. The lowest portion of the cooling unit 7 is adhered onto one side of the vacuum vessel 3.

The vacuum vessel 3 is connected to an exhaust pipe 8 made of metal that is connected to a vacuuming unit. On the lower portion of the vacuum vessel 3, there is an external connecting terminal 13 to electrically connect the inside and outside of the vacuum vessel 3. The terminal inside the vacuum vessel 3 in the external connecting terminal 13 and the infrared detecting unit 2 are electrically connected through an interconnection. Through this interconnection, a signal for driving the infrared detecting unit 2 is transmitted to the infrared detecting unit 2 from outside the vacuum vessel 3. Moreover, through this interconnection, an output signal from the infrared detecting unit 2 is sent outside the vacuum vessel 3.

Inside the vacuum vessel 3, a light shielding plate 14 for shielding the infrared ray from the target 30 is installed in contact with the inner wall of the vacuum vessel 3. The light shielding plate 14 is preferred to be made of the same material as the vacuum vessel 3. The light shielding plate 14 is further preferred to be formed integrally with the vacuum vessel 3.

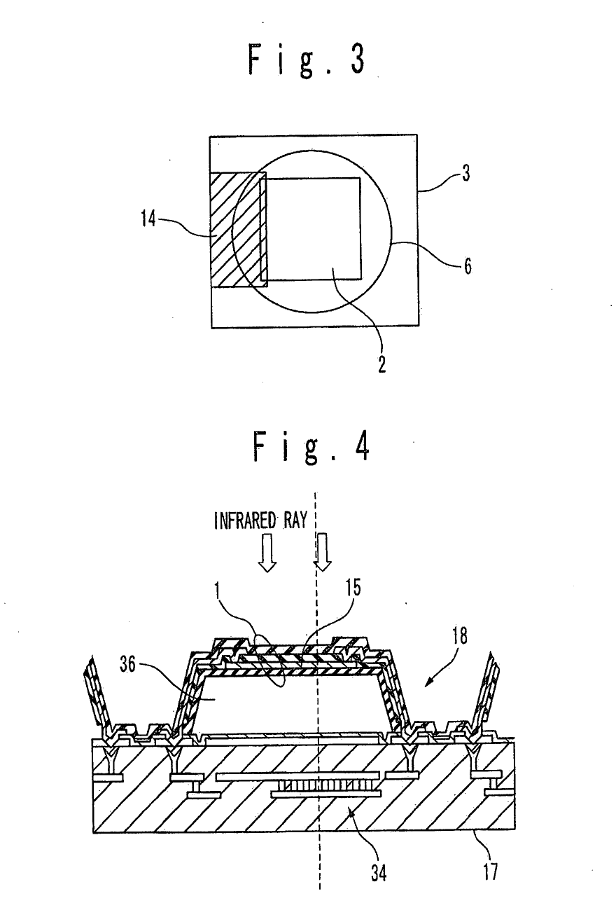

FIG. 3 shows the positional relation between the infrared detecting unit 2, the window 6 and the light shielding plate 14 when they are viewed from the normal direction on the surface where the infrared detecting device of the infrared detecting unit 2 is installed. Since the light shielding plate 14 blocks the infrared ray, a part of pixels in the infrared detecting unit 2 does not input the infrared ray entered through the window 6.

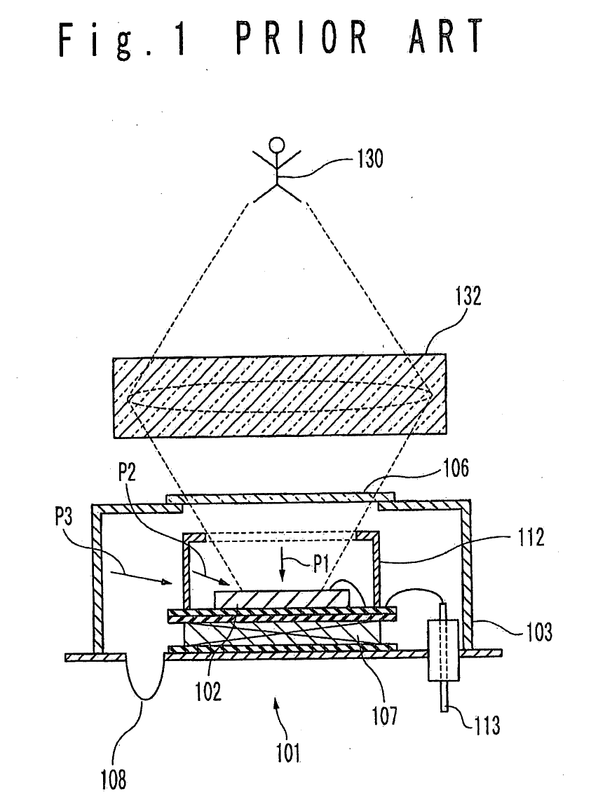

The thermal infrared detector 5 in this embodiment does not have the radiation shield 112 included in the thermal infrared detector 101 in the conventional technique shown in FIG. 1. When the infrared detecting unit 2 and the infrared detecting unit 102 are equal in size, the light shielding plate 14 can be made smaller than the radiation shield 112, and the space required to install the light shielding plate 14 is smaller than the space required to install the radiation shield 112. Thus, the thermal infrared detector 5 can be smaller and lighter than the thermal infrared detector 101.

The thermal infrared detector 5 in this embodiment does not require the radiation shield 112, which is cooled by Peltier device in the conventional technique. Therefore the electric power consumed in the cooling unit 107 is reduced.

FIG. 4 is a conceptual view when the configuration of one pixel among a plurality of pixels (namely, the infrared detecting devices) included in the infrared detecting unit 2 is viewed from the side. The infrared detecting unit 2 has a silicon wafer 17. For example, a MOS type circuit 34 for selecting a pixel is formed on the silicon wafer 17. A diaphragm 1 is supported by a beam 18 formed on the surface of the silicon wafer 17 (the surface facing the window 6). There is a cavity 36 between the diaphragm 1 and the surface of the silicon wafer 17. The diaphragm 1 and the silicon wafer 17 are coupled by the slim beam 18 and thermally separated. A bolometer 15 is attached to the diaphragm 1.

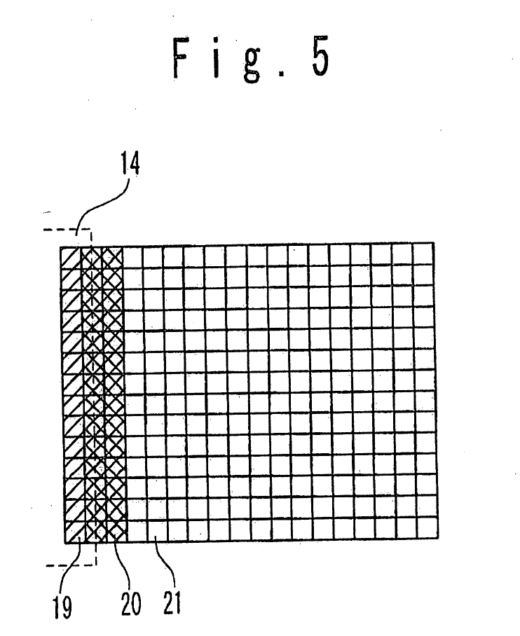

FIG. 5 shows the positional relation between the infrared detecting unit 2 and the light shielding plate 14 viewed from the normal direction of the surface of the infrared detecting unit 2 (namely, the side facing the window 6). A part of the pixels included by the infrared detecting unit 2 is a reference pixel 19 to which the infrared ray from the target 30 is not inputted because it is shielded by the light shielding plate 14. The other part of the pixels is a boundary pixel 20 where the infrared ray from the target 30 is partially shielded by the light shielding plate 14. The other portion of the pixels is a measuring pixel 21 to which the infrared ray from the target 30 is inputted without being shielded by the light shielding plate 14.

When the thermal infrared detector 5 is used, the inside of the vacuum vessel 3 is made vacuum by the exhaustion through the exhaust pipe 8 and isolation by closing the exhaust pipe 8. The vacuum vessel 3 is made vacuum, which improves the thermal separation between the diaphragm 1 and the silicon wafer 17. The cooling unit 7 is driven. The infrared detecting unit 2 is cooled by the cooling unit 7.

The diaphragm of the optical unit 32 is adjusted by the diaphragm unit 33. The thermal infrared detector 5 in this embodiment does not have the radiation shield 112 included in the thermal infrared detector 101 of the conventional invention. Thus, because the diaphragm of the optical unit is not limited by the radiation shield 112, the adjustment area of the diaphragm can be set wider.

The infrared detecting unit 2 is driven. The temperature increase in the diaphragm 1, which is caused by the input of the infrared ray, results in the respective shift in the resistance of each bolometer 15. The shift of the resistance of the bolometer 15 is read by applying a bias current. This bias current brings about Joule heating. This Joule heating increases the temperature of the bolometer 15 itself. This temperature increase extremely exceeds the temperature increase in the diaphragm 1 unless any countermeasure is executed. Since the cooling unit 7 cools the infrared detecting unit 2 and discharges the heat to the vacuum vessel 3, the temperature change caused by the Joule heating is suppressed.

The infrared detecting unit 2 detects a infrared ray and converts into an electronic signal. The electronic signal is sent through the external connecting terminal 13 to outside the vacuum vessel 3.

An infrared ray P1 from the target and an infrared ray P3 from the vacuum vessel are inputted to the measuring pixel 21 included in the infrared detecting unit 2. An infrared ray P4 from the light shielding plate is inputted to the reference pixel 19. Since the light shielding plate 14 is formed integrally with the vacuum vessel 3, the infrared ray P3 from the vacuum vessel and the infrared ray P4 from the light shielding plate can be supposed to be equal. Thus, by subtracting the infrared ray P4 from the light shielding plate, which is inputted to the reference pixel 19, from the infrared rays P1+P3 that are inputted to the measuring pixel 21, it is possible to extract the infrared ray P1 from the target, which is originally desired to be converted into a picture image.

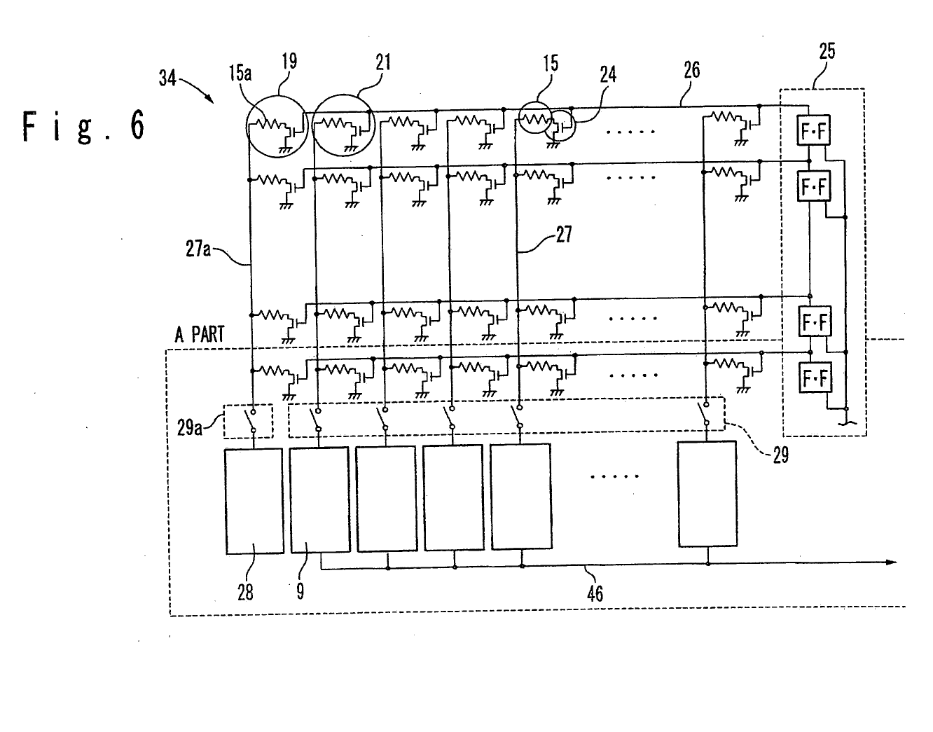

FIG. 6 shows an example of the circuit for extracting and reading the change in the input infrared quantity that is caused by the change in the infrared ray P1 from the target. The circuit 34 has the pixels placed in the arrangement of a two-dimensional matrix. Each of the pixels has the bolometer 15 and a pixel transistor 24. In this embodiment, the N-channel transistor is used. A predetermined row among the pixels includes a plurality of reference pixels 19. At least one row of the pixels drawn on the leftmost sides in FIG. 6 is the reference pixels 19. There may be two or more rows of the reference pixels 19. The reference pixels 19 may be the row of one or more pixels at the end area close to a scanning circuit which will be described later. The other pixels are the measuring pixels 21. The electronic signal outputted from the boundary pixel 20 is not used for the measurement and are not drawn in FIG. 6.

The gate of the reference pixels 19 and the gate of the measuring pixel 21 are connected to a common horizontal signal line 26 and controlled by a scanning circuit 25. The source of the reference pixel 19 and the source of the measuring pixel 21 are grounded. Each of drains of the reference pixels 19 is connected to one end of a reference bolometer 15a. The other end of each reference bolometer 15a is connected to a common vertical signal line 27a. The vertical signal line 27a is connected through a switch 29a to a reference voltage generating circuit 28.

Each of the drains of the measuring pixels 21 is connected to one end of the bolometer 15. The other end of each bolometer 15 is connected to a common vertical signal line 27 for each row. Each vertical signal line 27 is connected through a switch 29 to a reading circuit 9. The respective switches 29, 29a are independently controlled. The plurality of reading circuits 9 are connected to a common reading signal line 46.

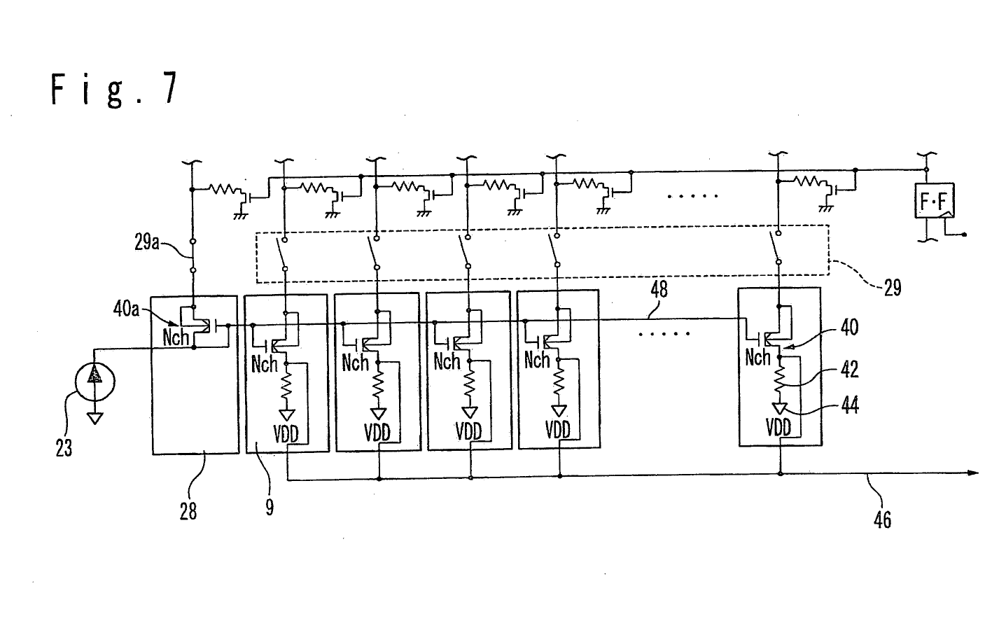

FIG. 7 is a view showing the area around the reading circuits 9. Each of the plurality of reading circuits 9 has a MOS transistor 40, a resistor 42 and a power source V_{DD}. A source of the MOS transistor 40 is connected through the switch 29 to the vertical signal line 27. The gate of each MOS transistor 40 is connected to a common horizontal signal line 48. The drain of each MOS transistor 40 is connected through the resistor 42 to the power source V_{DD}. A signal line is branched from a signal line through which each drain and the resistor 42 are connected, and connected to a common reading signal line 46.

The reference voltage generating circuit 28 has a MOS transistor 40a. The source of the MOS transistor 40a is connected through the switch 29a to the vertical signal line 27a. The drain is connected to a constant current source 23. The gate is connected to the drain and the horizontal signal line 48.

When the circuit 34 reads the electronic signal from the pixels, the state of the switch 29a is controlled to be on. The measuring pixels 21 placed in the arrangement of the matrix are sequentially appointed as follows. At first, the switches 29 are sequentially turned on, one by one. The switches 29 except the turned on switch are set to be off. Consequently, a certain one of the plurality of vertical signal lines 27 is selected. Among the measuring pixels 21 connected to the selected vertical signal line 27, with regard to the pixel sequentially selected by the scanning circuit 25 for controlling the pixel transistor 24, the resistance of the bolometer 15 is sequentially converted into the electronic signal and read by the reading circuit 9. In the bolometer 15, the resistance is shifted in response to the temperature change of the diaphragm 1 caused by the incident infrared ray. For this reason, the current to be read by the reading circuit 9 is determined in accordance with the input infrared quantity for each pixel. The two-dimensional picture image of the infrared ray emitted from the target 30 is generated by using the read current.

The constant current source 23 sends a constant current I₁ to the vertical signal line 27a to which the reference pixel 19 is connected. The reference bolometer 15a is the resistor of a resistance R and generates a voltage of V₁=RI₁ in accordance with the Ohm's law. The generated voltage V₁ is applied to the measuring pixel 21 by the operation of the current mirror circuit such as MOS and the like, or a bridge circuit. Thus, the voltage of the measuring pixel 21, with the voltage of the reference pixel 19 as the baseline (namely, the reference voltage), is read by the reading circuit 9.

Here, let us consider the case where the environmental temperature is changed. The infrared ray from the light shielding plate 14 which is inputted to the reference pixel 19 and the infrared ray from the inner wall of the vacuum vessel 3 which is inputted to the measuring pixel 21 are equal in quantity. For this reason, in the reference pixel 19 and the measuring pixel 21, the changed resistance values are equal. As a result, the reading circuit 9 outputs the electronic signal corresponding to the infrared ray inputted from the target 30 to the reading signal line 46. The influence of the change of the environmental temperature is suppressed. The above mentioned circuit is only one of the possible embodiments. Then, the circuit having a different configuration may be applied, if it is the circuit for reading the electronic signal from the measuring pixel 21 with the reference pixel 19 as a baseline.

What is claimed is:

1. An infrared detector comprising:
a plurality of infrared detecting devices configured to convert an incident infrared ray into an electric signal;
a shielding member configured to prevent an infrared ray radiated from a target object from inputted to a reference device which is a part of said plurality of infrared detecting devices; and
a circuit configured to read a deviation of an electronic signal generated by a part of said plurality of infrared detecting device from an electronic signal generated by said reference device.

2. The infrared detector according to claim 1, further comprising:
a vessel having a space in which said plurality of infrared detecting devices and said shielding member are placed,
wherein said vessel is connected to said shielding member.

3. The infrared detector according to claim 2, wherein said shielding member is made of a same material as said vessel.

4. The infrared detector according to claim 1, further comprising:
a diaphragm unit configured to control a diaphragm of an optical system a focus of which is set on said plurality of infrared detecting devices.

5. A infrared detector comprising:
an infrared detecting device configured to convert an incident infrared ray into a first electric signal;
a reference device configured to convert an incident infrared signal into a second electric signal; and
a circuit configured to read a deviation of said first electric signal from said second electric signal.
